(19) United States
(12) Patent Application Publication
(10) Pub. No.: US 2017/0277228 A1
(43) Pub. Date: Sep. 28, 2017

(54) ELECTRONIC DEVICE WITH KEYBOARD PROTECTION

(71) Applicant: Intel Corporation, Santa Clara, CA (US)

(72) Inventors: Hong W. Wong, Portland (US); Christine Kim, San Jose, CA (US); Wah Yiu Kwong, Hillsboro, OR (US); Jiancheng Johnson Tao, Shanghai (CN); Xiaoguo Liang, Shanghai (CN)

(73) Assignee: Intel Corporation, Santa Clara, CA (US)

(21) Appl. No.: 15/507,978

(22) PCT Filed: Oct. 3, 2014
(86) PCT No.: PCT/CN2014/088098

§ 371 Date: Mar. 1, 2017

(51) Int. Cl. G06F 1/16; G06F 3/02

(52) U.S. Cl. CPC G06F 1/1681; G06F 1/1666; G06F 3/0221

(57) ABSTRACT

Particular embodiments described herein provide for an electronic device, such as a notebook computer or laptop, that includes a circuit board coupled to a plurality of electronic components (which includes any type of components, elements, circuitry, etc.). One particular example implementation of the electronic device may include a first housing, a hinge, and a second housing. The second housing can be rotatably coupled to the first housing using the hinge. The second housing can include a first portion, a second hinge, and a second portion. The second portion can be rotatably coupled to the first portion using the second hinge. In an embodiment, the second portion can rotate over the keyboard and the second housing can rotate behind the display. In another embodiment, the second portion can rotate over the key-board and the second housing can rotate in front of the display such that only a portion of display is visible.

### TECHNICAL FIELD

Embodiments described herein generally relate to the field of electronic devices and, more particularly, to keyboard protection for an electronic device.

### BACKGROUND

End users have more electronic device choices than ever before. A number of prominent technological trends are currently afoot (e.g., more computing devices, more detachable displays, etc.), and these trends are changing the electronic device landscape. One of the technological trends is a convertible or hybrid laptop. The convertible laptop is any type of computer system that has a display and can essentially function as either a laptop or a tablet computer. In many instances, the keyboard can rotate about a hinge around the display. However, when the keyboard is rotated to the back of the display, the keys of the keyboard are exposed. Hence, there is a challenge in providing an electronic device that allows for protection of the keyboard.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified schematic diagram illustrating an embodiment of an electronic device, in accordance with one embodiment of the present disclosure;

FIG. 1B is a simplified schematic diagram illustrating an embodiment of an electronic device, in accordance with one embodiment of the present disclosure;

FIG. 1C is a simplified schematic diagram illustrating an embodiment of an electronic device, in accordance with one embodiment of the present disclosure;

FIG. 1D is a simplified schematic diagram illustrating an embodiment of an electronic device, in accordance with one embodiment of the present disclosure;

FIG. 1E is a simplified schematic diagram illustrating an embodiment of an electronic device, in accordance with one embodiment of the present disclosure;

FIG. 1F is a simplified schematic diagram illustrating an embodiment of an electronic device, in accordance with one embodiment of the present disclosure;

FIG. 2A is a simplified schematic diagram illustrating an embodiment of an electronic device, in accordance with one embodiment of the present disclosure;

FIG. 2B is a simplified schematic diagram illustrating an embodiment of an electronic device, in accordance with one embodiment of the present disclosure;

FIG. 2C is a simplified schematic diagram illustrating an embodiment of n electronic device, in accordance with one embodiment of the present disclosure;

FIG. 2D is a simplified schematic diagram illustrating an embodiment of an electronic device, in accordance with one embodiment of the present disclosure;

FIG. 3 is a simplified schematic diagram illustrating an embodiment of an electronic device, in accordance with one embodiment of the present disclosure;

FIG. 4 is a simplified schematic diagram illustrating an embodiment of a portion of an electronic device in accordance with one embodiment of the present disclosure;

FIG. 5 is a simplified schematic diagram illustrating an embodiment of an electronic device, in accordance with one embodiment of the present disclosure;

FIG. 6 is a simplified flow diagram illustrating potential operations associated with one embodiment of the present disclosure;

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Overview

An electronic device is provided in one example embodiment and includes a plurality of electronic components (which can include any type of components, elements, circuitry, etc.). One particular example implementation of the electronic device may include a first housing, a hinge, and a second housing. The second housing can be rotatably coupled to the first housing using the hinge. The second housing can include a first portion, a second hinge, and a second portion. The second portion can be rotatably coupled to the first portion using the second hinge.

In other embodiments, the second housing can rotate about three hundred and sixty degrees relative to the first housing. Additionally, the second portion can rotate about three hundred and sixty degrees relative to the first portion. In still other embodiments, the first housing can include a display and the first portion of the second housing can include a keyboard. Also, the second portion may include a touchpad. In certain examples, the second portion can rotate over the keyboard and the second housing can rotate behind the display. In addition, the second portion can rotate over the keyboard and the second housing can rotate in front of the display such that only a portion of display is visible.

### Example Embodiments

The following detailed description sets forth example embodiments of apparatuses, methods, and systems relating to detachable display configurations for an electronic device. Features such as structure(s), function(s), and/or characteristic(s), for example, are described with reference to one embodiment as a matter of convenience; various embodiments may be implemented with any suitable one or more of the described features.

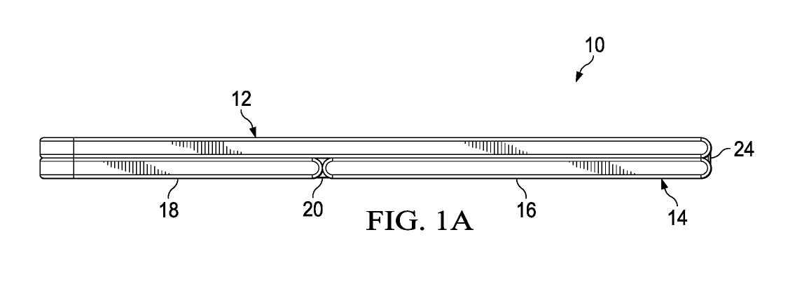

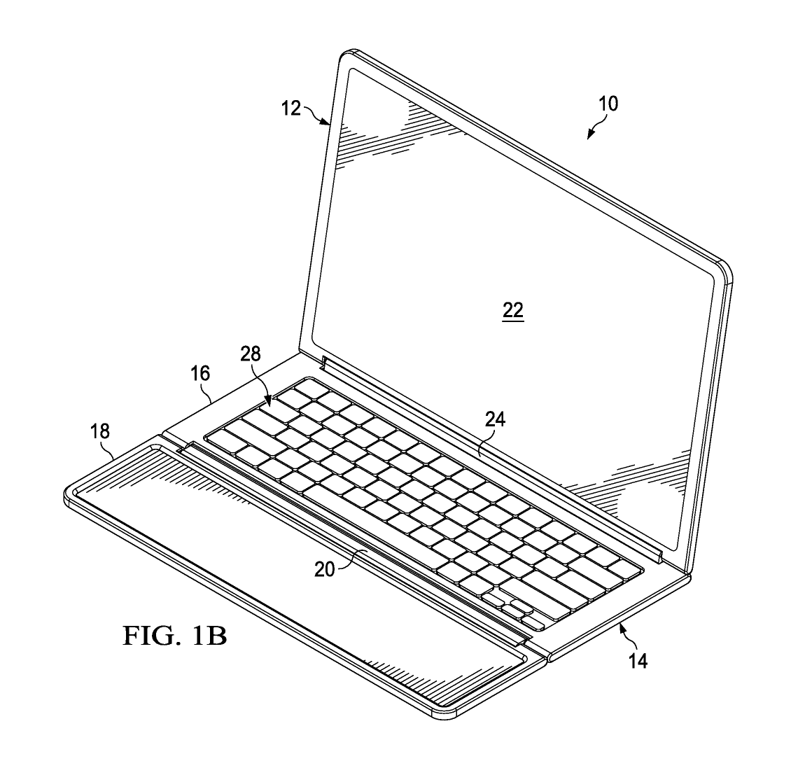

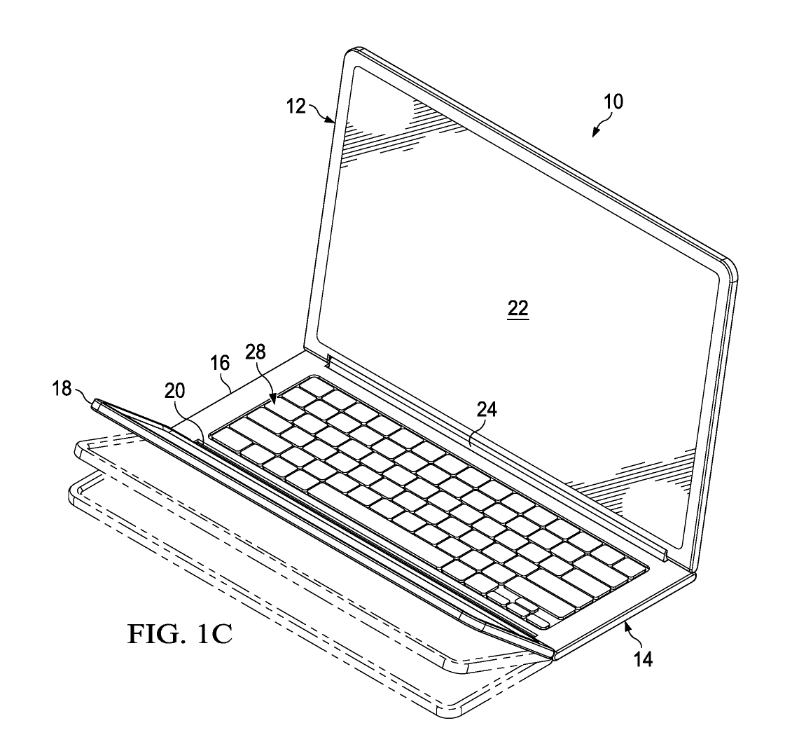

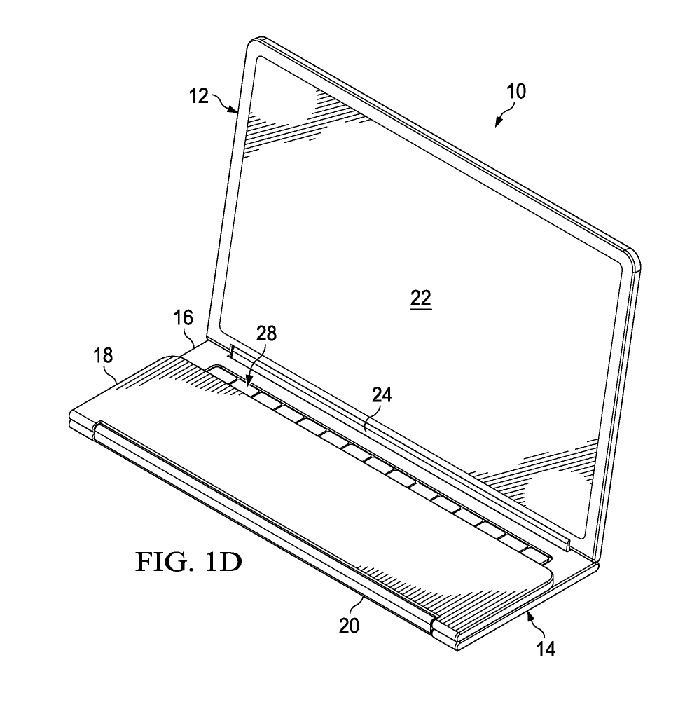

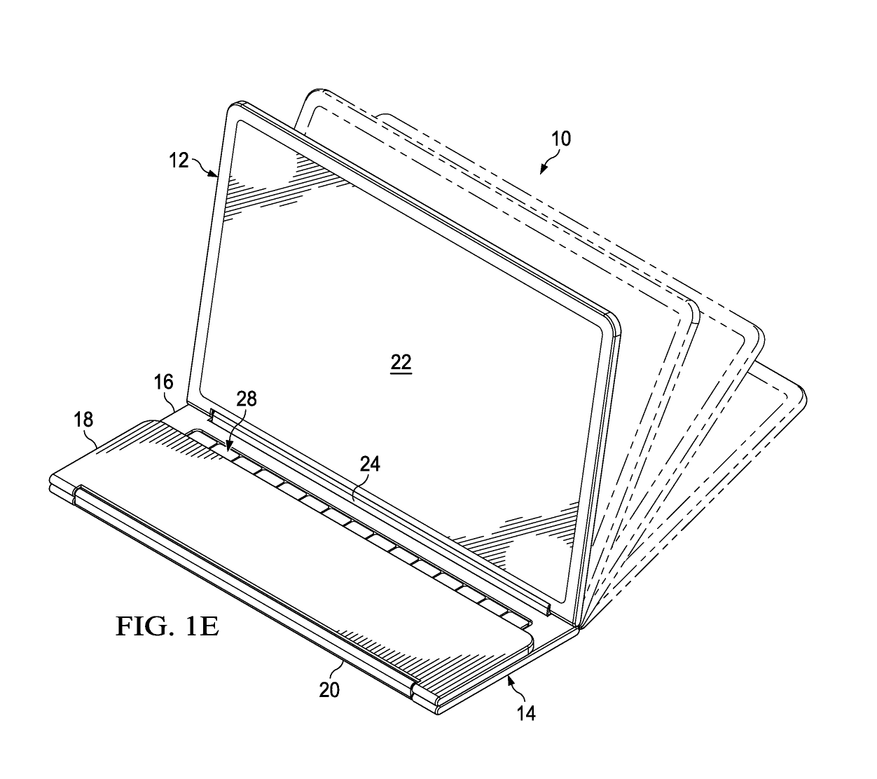

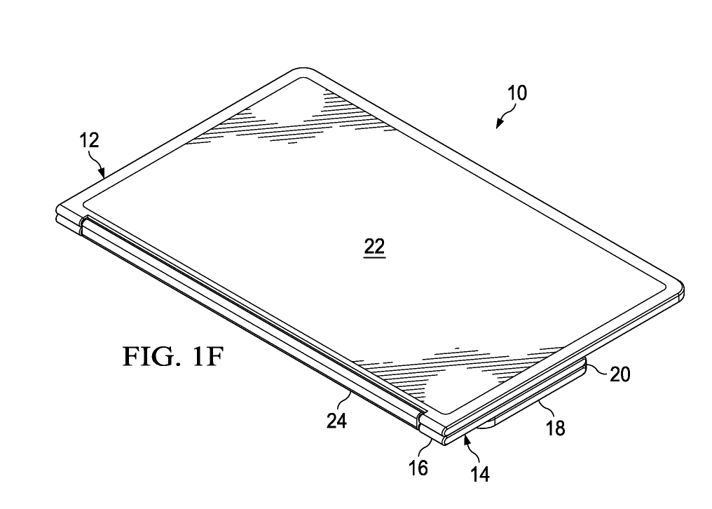

FIG. 1A is a simplified schematic diagram illustrating an embodiment of an electronic device 10 in a closed clamshell configuration in accordance with one embodiment of the present disclosure. Electronic device 10 may include a first housing 12, a second housing 14, and a hinge 24. Second housing 14 can include a keyboard portion 16, a touchpad portion 18, and a second housing hinge 20. Hinge 24 can define an axis of rotation that is shared between first housing 12 and second housing 14. Second housing hinge 20 can define an axis of rotation that is shared between keyboard portion 16 and touchpad portion 18.

In one or more embodiments, electronic device 10 is a tablet computer. In still other embodiments, electronic device 10 may be any suitable electronic device having a display such as a mobile device, a tablet device (e.g., i-Pad™), Phablet™, a personal digital assistant (PDA), a smartphone, an audio system, a movie player of any type, a computer docking station, etc. In an embodiment, most of the electronics (e.g., processor, memory, etc.) for electronic device 10 reside in first housing 12. In yet another embodiment, most of the electronics (e.g., processor, memory, etc.) for electronic device 10 reside in second housing 14.

Turning to FIG. 1B, FIG. 1B is a simplified schematic diagram of electronic device 10 in an open clamshell configuration, in accordance with one embodiment of the present disclosure. Keyboard portion 16 can include keys 28. First housing 12 can include a display 22. In one or more embodiments, display 22 can be a liquid crystal display (LCD) display screen, a light-emitting diode (LED) display screen, an organic light-emitting diode (OLED) display screen, a plasma display screen, or any other suitable display screen system. Display 22 may be a touchscreen that can detect the presence and location of a touch within the display area. In another embodiment, first housing 12 may include a battery and various electronics (e.g., processor, memory, etc.) to allow first housing 12 to operate as a standalone tablet. In another embodiment, first housing 12 may include a wireless module (e.g., Wi-Fi module, Bluetooth module, etc.). In yet another embodiment, first housing 12 may include a camera, a microphone, and speakers.

Turning to FIG. 1C, FIG. 1C is a simplified schematic diagram of electronic device 10 in accordance with one embodiment of the present disclosure. As illustrated in FIG. 1C, touchpad portion 18has been rotated on second housing hinge 20 towards keyboard portion 16. Turning to FIG. 1D, FIG. 1D is a simplified schematic diagram of electronic device 10 in accordance with one embodiment of the present disclosure. As illustrated in FIG. 1D, touchpad portion 18 has been rotated on second housing hinge 20 such that touchpad portion 18 covers at least a portion or part of keys 28 in keyboard portion 16.

Turning to FIG. 1E, FIG. 1E is a simplified schematic diagram of electronic device 10 in accordance with one embodiment of the present disclosure. As illustrated in FIG. 1E, first housing 12 can be rotated on hinge 24 away from keyboard portion 16. Turning to FIG. 1F, FIG. 1F is a simplified schematic diagram illustrating an embodiment of an electronic device 10 in a tablet configuration in accordance with one embodiment of the present disclosure. As illustrated in FIG. 1F,first housing 12 has been rotated around second housing 14 such that display 22 faces one direction and keyboard portion 16 faces the opposite direction. In this configuration, touchpad portion 18 is covering at least a portion of keys 28 (not shown) and thus allows for protection of keys 28 and keyboard portion 16.In general terms, electronic device 10 may be configured to provide keyboard protection when electronic device 10 is in a tablet configuration.

For purposes of illustrating certain example features of electronic device 10, the following foundational information may be viewed as a basis from which the present disclosure may be properly explained. A two-in-one system (e.g., a convertible laptop) is any type of computer system that has a display and can essentially function with a keyboard in front of a display (e.g., as a laptop) or with the keyboard behind the display (e.g., as a tablet computer). In many instances, the keyboard can rotate about a hinge around the display. However, when the keyboard is rotated to the back of the display, the keys of the keyboard are exposed. Hence, there is a challenge in providing an electronic device that allows for protection of the keyboard when the keyboard is rotated to the back of the display.

Particular embodiments described herein provide for an electronic device, such as a notebook computer, laptop, cellphone, or other mobile device that includes a circuit board coupled to a plurality of electronic components (which includes any type of components, elements, circuitry, etc.). The electronic device may also include a first housing coupled to a second housing to allow the second housing to rotate relative to the first housing. The electronic device may further include a second housing hinge that allows a first portion of the second housing to rotate relative to a second portion of the second housing. For example, the second housing can include a touch pad portion and a keyboard portion and the touchpad portion could rotate on the hinge and cover at least a portion of a keyboard portion.

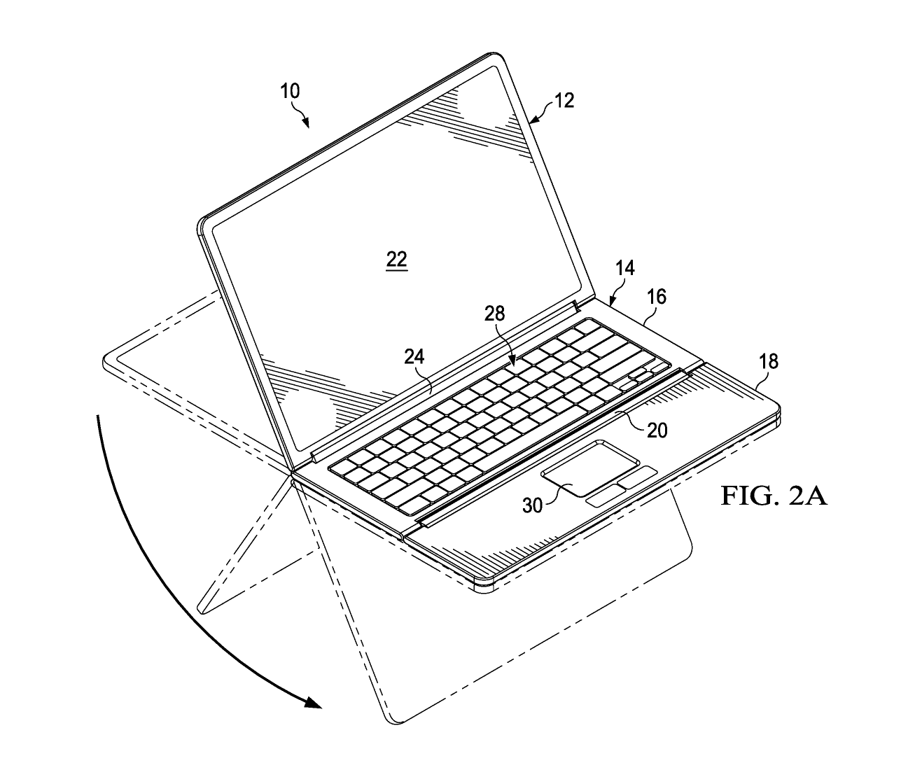

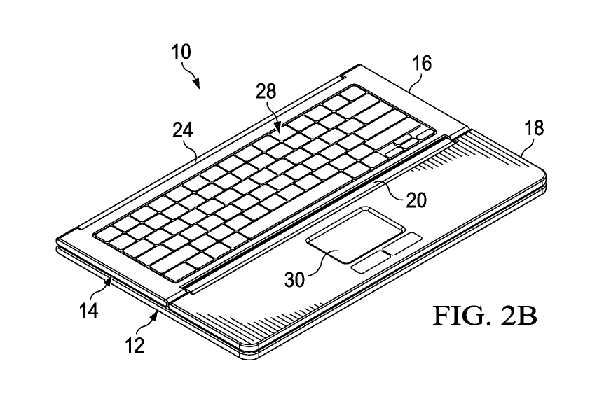

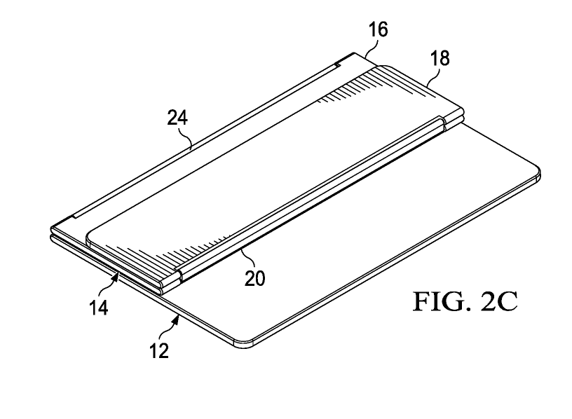

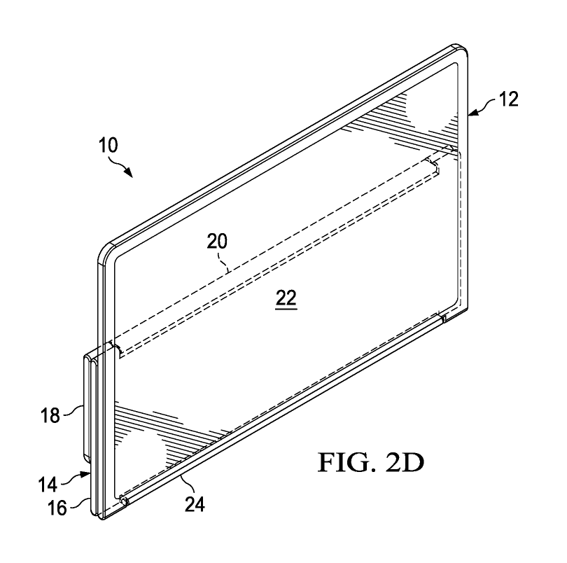

Turning to FIG. 2A, FIG. 2A is a simplified schematic diagram illustrating an embodiment of electronic device 10, in accordance with one embodiment of the present disclosure. Second housing 14 can include keys 28 and a touchpad 30. As illustrated in FIG. 2A, first housing 12 can rotate three hundred and sixty degrees (360°) or about 360° relative to second housing 14 using hinge 24.

Turning to FIG. 2B, FIG. 2B is a simplified schematic diagram illustrating an embodiment of electronic device 10, in accordance with one embodiment of the present disclosure. As illustrated in FIG. 2B, first housing 12 has been rotated to the back of second housing 16 such that display 22 (not shown) is facing one direction and keys 28 and touchpad 30 are facing the opposite direction. Touchpad portion 18 can rotate towards keys 28.

Turning to FIG. 2C, FIG. 2C is a simplified schematic diagram illustrating an embodiment of electronic device 10, in accordance with one embodiment of the present disclosure. As illustrated in FIG. 2C, touchpad portion 18 has been rotated towards keys 28 such that touchpad portion 18 covers at least a portion of keyboard portion 16. As illustrated in FIG. 2C, touchpad portion 18 covers all of keys 28 and thus provides protection of keys 28. Turning to FIG. 2D, FIG. 2D is a simplified schematic diagram illustrating an embodiment of electronic device 10, in accordance with one embodiment of the present disclosure. As illustrated in FIG. 2C, electronic device 10 can be used as a tablet where keys 28 in keyboard portion 16 are protected.

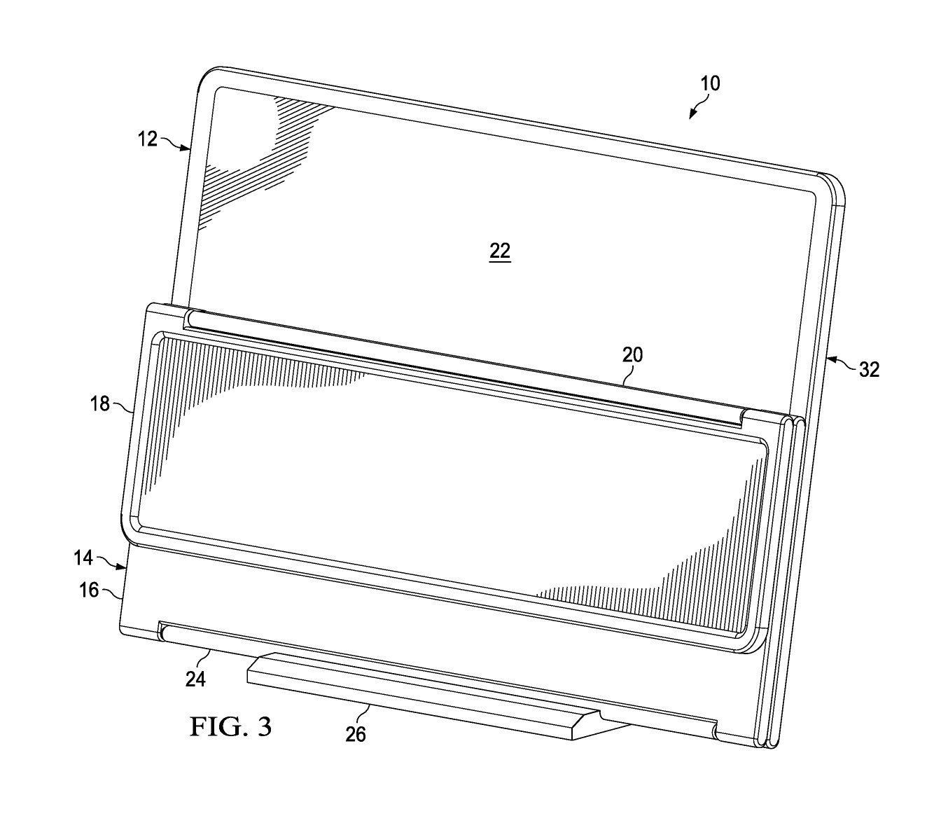

Turning to FIG. 3, FIG. 3 is a simplified schematic diagram illustrating an embodiment of electronic device 10, in accordance with one embodiment of the present disclosure. In an embodiment, electronic device 10 can be connected to a docking station 26 or a stand. In this configuration, touchpad portion 18 may be rotated away from keys 28 and second housing 14 may be rotated towards first housing 12 similar to a closed laptop configuration. As illustrated in FIG. 3, only a top portion 32 of display 22 may be visible. Top portion 32 can be configured to displaying messages (e.g., text messages, song titles, caller ID, email, a clock, etc.)or other applications such as an aesthetic image or to provide some illumination (e.g., a night light). In one example,electronic device can be configured to reduce the overall system power and only power top portion 32 of display 22.

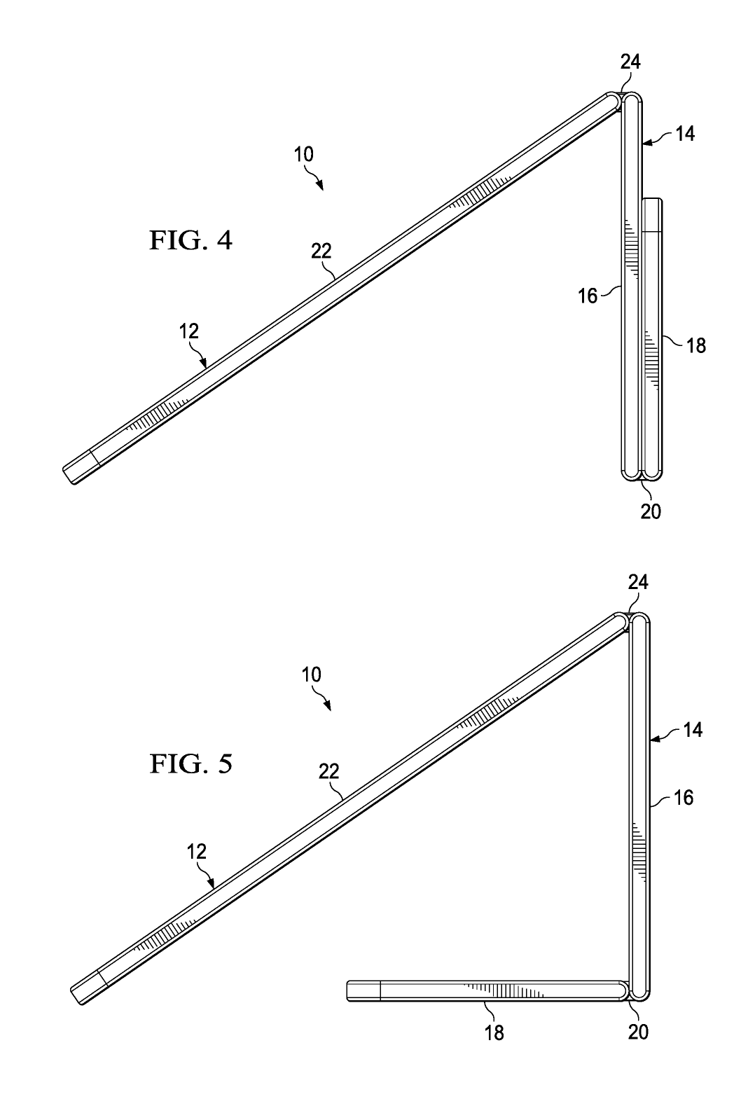

Turning to FIG. 4, FIG. 4 is a simplified schematic diagram illustrating an embodiment of electronic device, in accordance with one embodiment of the present disclosure. In an embodiment, touchpad portion 18 can be rotated onto keyboard portion 16. Second housing 14 can then be rotated relative to first housing 12 such that second housing 14 can function as a stand for first housing 12.

Turning to FIG. 5, FIG. 5 is a simplified schematic diagram illustrating an embodiment of electronic device, in accordance with one embodiment of the present disclosure. In an embodiment, touchpad portion 18 can be rotated to about a ninety degree (90°) angle relative to keyboard portion 16. Second housing 14 can then be rotated relative to first housing 12 such that second housing 14 can function as a relatively stable base or stand for first housing 12.

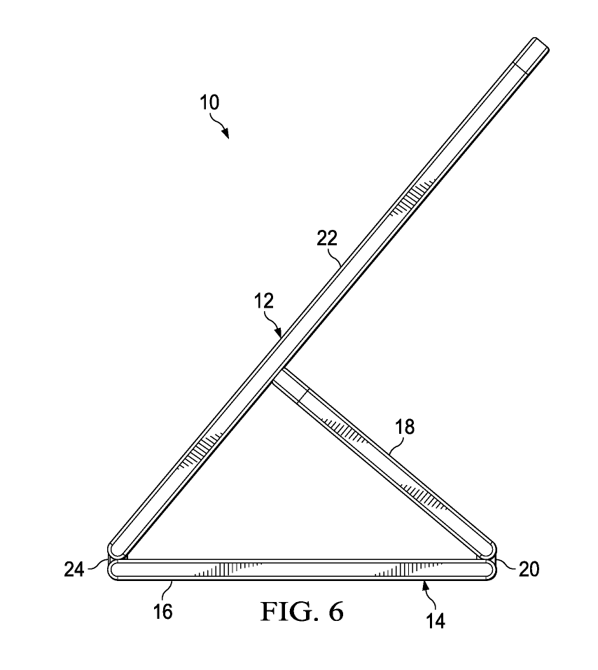

Turning to FIG. 6, FIG. 6 is a simplified schematic diagram illustrating an embodiment of electronic device, in accordance with one embodiment of the present disclosure. In an embodiment, touchpad portion 18 can be rotated to a forty-five degree (45°) angle (or one hundred and thirty-five degrees (135°)) relative to keyboard portion 16. Second housing 14 can then be rotated relative to first housing 12 such that touchpad portion 18 can function as a relatively stable base or stand for first housing 12.

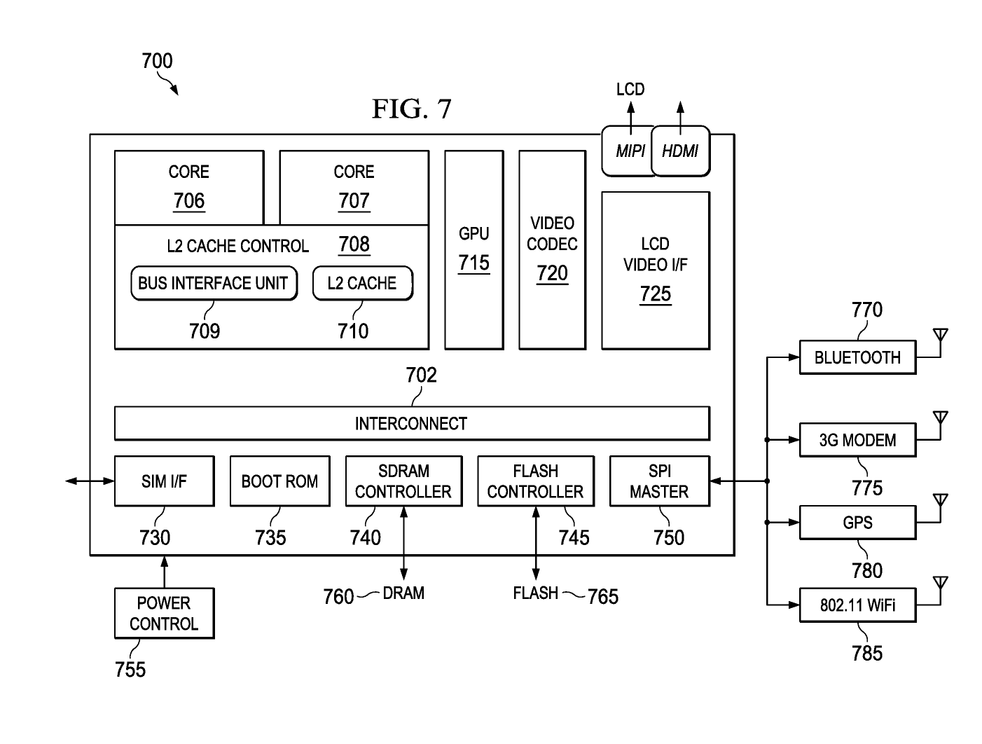

Turning to FIG. 7, FIG. 7 is a simplified block diagram associated with an example ARM ecosystem SOC 700 of the present disclosure. At least one example implementation of the present disclosure can include the keyboard protection features discussed herein and an ARM component. For example, the example of FIG. 7 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more example embodiments include one or more communication capabilities, interfaces, and features such as instances of Bluetooth™770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

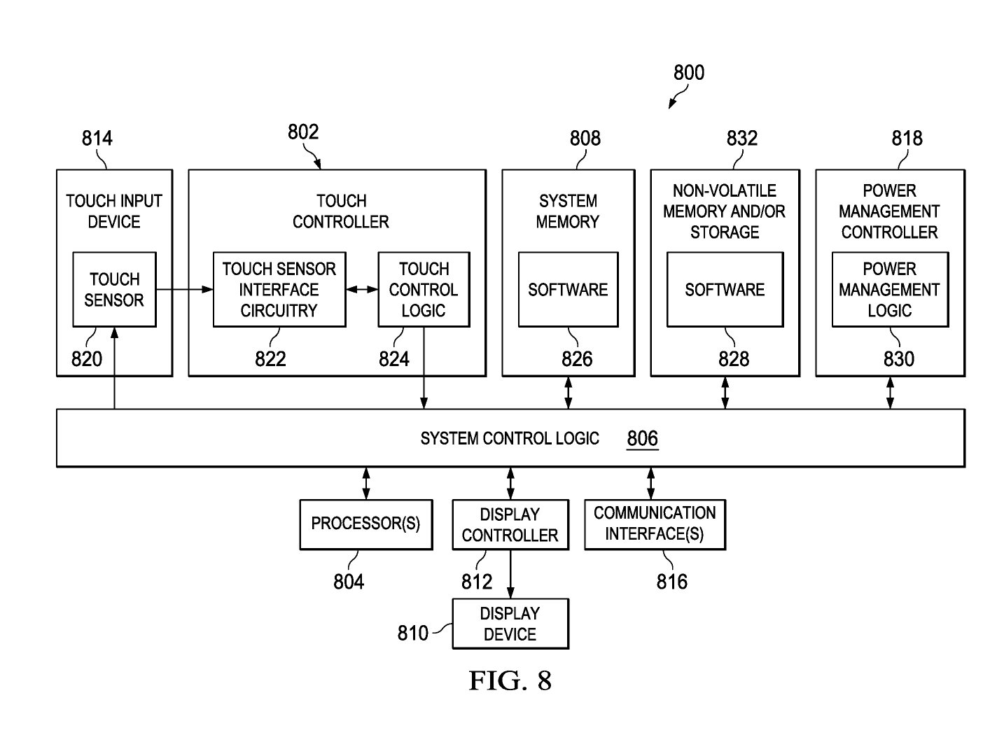

Turning to FIG. 8, FIG. 8 is a simplified block diagram illustrating potential electronics and logic that may be associated with any of the electronic devices discussed herein. In at least one example embodiment, system 800 can include a touch controller 802, one or more processors 804, system control logic 806 coupled to at least one of processor(s) 804, system memory 808 coupled to system control logic 806, non-volatile memory and/or storage device(s) 832 coupled to system control logic 806, display controller 812 coupled to system control logic 806, display controller 812 coupled to a display device 810, power management controller 818 coupled to system control logic 806, and/or communication interfaces 816 coupled to system control logic 806.

System control logic 806, in at least one embodiment, can include any suitable interface controllers to provide for any suitable interface to at least one processor 804 and/or to any suitable device or component in communication with system control logic 806. System control logic 806, in at least one example embodiment, can include one or more memory controllers to provide an interface to system memory 808. System memory 808 may be used to load and store data and/or instructions, for example, for system 800. System memory 808, in at least one example embodiment, can include any suitable volatile memory, such as suitable dynamic random access memory (DRAM) for example. System control logic 806, in at least one example embodiment, can include one or more I/O controllers to provide an interface to display device 810, touch controller 802, and non-volatile memory and/or storage device(s) 832.

Non-volatile memory and/or storage device(s) 832 may be used to store data and/or instructions, for example within software 828. Non-volatile memory and/or storage device(s) 832 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 818 may include power management logic 830 configured to control various power management and/or power saving functions disclosed herein or any part thereof. In at least one example embodiment, power management controller 818 is configured to reduce the power consumption of components or devices of system 800 that may either be operated at reduced power or turned off when the electronic device is in a closed configuration. For example, in at least one example embodiment, when the electronic device is in a closed configuration, power management controller 818 performs one or more of the following: power down the unused portion of the display and/or any backlight associated therewith; allow one or more of processor(s) 804 to go to a lower power state if less computing power is required in the closed configuration; and shutdown any devices and/or components that are unused when an electronic device is in the closed configuration.

Communications interface(s) 816 may provide an interface for system 800 to communicate over one or more networks and/or with any other suitable device. Communications interface(s) 816 may include any suitable hardware and/or firmware. Communications interface(s) 816, in at least one example embodiment, may include, for example, a network adapter, a wireless network adapter, a telephone modem, and/or a wireless modem.

System control logic 806, in at least one example embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 804 may be packaged together with logic for one or more controllers of system control logic 806. In at least one example embodiment, at least one processor 804 may be packaged together with logic for one or more controllers of system control logic 806 to form a System in Package (SiP). In at least one example embodiment, at least one processor 804 may be integrated on the same die with logic for one or more controllers of system control logic 806. For at least one example embodiment, at least one processor 804 may be integrated on the same die with logic for one or more controllers of system control logic 806 to form a System on Chip (SoC).

For touch control, touch controller 802 may include touch sensor interface circuitry 822 and touch control logic 824. Touch sensor interface circuitry 822 may be coupled to detect touch input over a first touch surface layer and a second touch surface layer of a display (i.e., display device 810). Touch sensor interface circuitry 822 may include any suitable circuitry that may depend, for example, at least in part on the touch-sensitive technology used for a touch input device. Touch sensor interface circuitry 822, in one embodiment, may support any suitable multi-touch technology. Touch sensor interface circuitry 822, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 824 may be coupled to help control touch sensor interface circuitry 822 in any suitable manner to detect touch input over a first touch surface layer and a second touch surface layer. Touch control logic 824 for at least one example embodiment may also be coupled to output in any suitable manner digital touch input data corresponding to touch input detected by touch sensor interface circuitry 822. Touch control logic 824 may be implemented using any suitable logic, including any suitable hardware, firmware, and/or software logic (e.g., non-transitory tangible media), that may depend, for example, at least in part on the circuitry used for touch sensor interface circuitry 822. Touch control logic 824 for at least one embodiment may support any suitable multi-touch technology.

Touch control logic 824 may be coupled to output digital touch input data to system control logic 806 and/or at least one processor 804 for processing. At least one processor 804 for at least one embodiment may execute any suitable software to process digital touch input data output from touch control logic 824. Suitable software may include, for example, any suitable driver software and/or any suitable application software. As illustrated in FIG. 8, system memory 808 may store suitable software 826 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example A1 is an electronic device that includes a first housing, a hinge, and a second housing, where the second housing is rotatably coupled to the first housing using the hinge. The second housing includes a first portion, a second hinge, and a second portion, where the second portion is rotatably coupled to the first portion using the second hinge.

In Example A2, the subject matter of Example A1 may optionally include where the second housing can rotate about three hundred and sixty degrees relative to the first housing.

In Example A3, the subject matter of any of the preceding ‘A’ Examples can optionally include where the second portion can rotate about three hundred and sixty degrees relative to the first portion.

In Example A4, the subject matter of any of the preceding ‘A’ Examples can optionally include where the first housing includes a display.

In Example A5, the subject matter of any of the preceding ‘A’ Examples can optionally include where the first portion of the second housing includes a keyboard.

In Example A6, the subject matter of any of the preceding ‘A’ Examples can optionally include where the second portion can rotate over the keyboard and the second housing can rotate behind the display.

In Example A7, the subject matter of any of the preceding ‘A’ Examples can optionally include where the second portion can rotate over the keyboard and the second housing can rotate in front of the display such that only a portion of display is visible.

In Example A8, the subject matter of any of the preceding ‘A’ Examples can optionally include where the second portion includes a touchpad.

Example M1 is a method that includes rotating a first housing relative to a second housing about a hinge, where the hinge rotatably couples the first housing and the second housing, where the second housing includes a first portion and a second portion and rotating the second portion relative to the first portion about a second hinge.

In Example M2, the subject matter of any of the preceding ‘M’ Examples can optionally include where the first housing includes a display and the second housing includes a keyboard, and where the first housing rotates such that the display faces one direction and the keyboard faces the opposite direction.

In Example M3, the subject matter of any of the preceding ‘M’ Examples can optionally include where the second portion rotates to cover at least a portion of the keyboard.

In Example M4, the subject matter of any of the preceding ‘M’ Examples can optionally include where the first housing includes a display and the second housing includes a keyboard, and where the first housing rotates such that the second portion covers at least a portion of the display.

In Example M5, the subject matter of any of the preceding ‘M’ Examples can optionally include where the second portion includes a touchpad.

In Example M6, the subject matter of any of the preceding ‘M’ Examples can optionally include where the second portion can rotate about three hundred and sixty degrees relative to the first portion.

In Example M7, the subject matter of any of the preceding ‘M’ Examples can optionally include where the second housing can rotate about three hundred and sixty degrees relative to the first housing.

Example AA1 can include a first housing, a hinge, and a second housing. The second housing is rotatably coupled to the first housing using the hinge and the second housing can rotate about three hundred and sixty degrees relative to the first housing. The second housing includes a first portion, a second hinge, and a second portion. The second portion is rotatably coupled to the first portion using the second hinge and the second portion can rotate about three hundred and sixty degrees relative to the first portion.

In Example AA2, the subject matter of any of the preceding ‘AA’ Examples can optionally include where the first housing includes a display and the first portion includes a keyboard.

In Example AA3, the subject matter of any of the preceding ‘AA’ Examples can optionally include where the second portion can rotate and cover at least a portion of the keyboard and the second housing can rotate behind the display.

In Example AA4, the subject matter of any of the preceding ‘AA’ Examples can optionally include where the second portion can rotate and cover at least a portion of the keyboard and the second housing can rotate in front of the display such that only a portion of display is visible.

An example system S1 can include a means for rotating a first housing relative to a second housing about a hinge, where the hinge rotatably couples the first housing and the second housing and the first housing can rotate about three hundred and sixty degrees relative to the second housing, where the second housing includes a first portion and a second portion and means for rotating the second portion relative to the first portion about a second hinge, where the second portion can rotate about three hundred and sixty degrees relative to the first portion.

In Example S2, the subject matter of any of the preceding ‘S’ Examples can optionally include where the first housing includes a display and the first portion includes a keyboard.

In Example S3, the subject matter of any of the preceding ‘S’ Examples can optionally include where the second portion can rotate and cover at least a portion of the keyboard.

In Example S4, the subject matter of any of the preceding ‘S’ Examples can optionally include where the second portion can rotate and cover at least a portion of the keyboard and the second housing can rotate in front of the display such that only a portion of display is visible.

In Example S5, the subject matter of any of the preceding ‘S’ Examples can optionally include where the second portion includes a touchpad.

Example X1 is a machine-readable storage medium including machine-readable instructions to implement a method or realize an apparatus as in any one of the Examples A1-A8, M1-M7, and AA1-AA4. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

1. An electronic device, comprising:
a first housing;
a hinge; and
a second housing, wherein the second housing is rotatably coupled to the first housing using the hinge, wherein the second housing includes:
a first portion;
a second hinge; and
a second portion, wherein the second portion is rotatably coupled to the first portion using the second hinge.

2. The electronic device of claim 1, wherein the second housing can rotate about three hundred and sixty degrees relative to the first housing.

3. The electronic device of claim 1, wherein the second portion can rotate about three hundred and sixty degrees relative to the first portion.

4. The electronic device of claim 1, wherein the first housing includes a display.

5. The electronic device of claim 4, wherein the first portion of the second housing includes a keyboard.

6. The electronic device of claim 5, wherein the second portion can rotate over the keyboard and the second housing can rotate behind the display.

7. The electronic device of claim 5, wherein the second portion can rotate over the keyboard and the second housing can rotate in front of the display such that only a portion of display is visible.

8. The electronic device of claim 1, wherein the second portion includes a touchpad.

9. A method, comprising:
rotating a first housing relative to a second housing about a hinge, wherein the hinge rotatably couples the first housing and the second housing, wherein the second housing includes a first portion and a second portion; and
rotating the second portion relative to the first portion about a second hinge.

10. The method of claim 9, wherein the first housing includes a display and the second housing includes a keyboard, and wherein the first housing rotates such that the display faces one direction and the keyboard faces the opposite direction.

11. The method of claim 10, wherein the second portion rotates to cover at least a portion of the keyboard.

12. The method of claim 9, wherein the first housing includes a display and the second housing includes a keyboard, and wherein the first housing rotates such that the second portion covers at least a portion of the display.

13. The method of claim 9, wherein the second portion includes a touchpad.

14. The method of claim 9, wherein the second portion can rotate about three hundred and sixty degrees relative to the first portion.

15. The method of claim 9, wherein the second housing can rotate about three hundred and sixty degrees relative to the first housing.

16. An electronic device, comprising:
a first housing;
a hinge; and
a second housing, wherein the second housing is rotatably coupled to the first housing using the hinge and the second housing can rotate about three hundred and sixty degrees relative to the first housing, wherein the second housing includes:
a first portion;
a second hinge; and
a second portion, wherein the second portion is rotatably coupled to the first portion using the second hinge and the second portion can rotate about three hundred and sixty degrees relative to the first portion.

17. The electronic device of claim 16, wherein the first housing includes a display and the first portion includes a keyboard.

18. The electronic device of claim 17, wherein the second portion can rotate and cover at least a portion of the keyboard and the second housing can rotate behind the display.

19. The electronic device of claim 17, wherein the second portion can rotate and cover at least a portion of the keyboard and the second housing can rotate in front of the display such that only a portion of display is visible.

20. A system, comprising:
means for rotating a first housing relative to a second housing about a hinge, wherein the hinge rotatably couples the first housing and the second housing and the first housing can rotate about three hundred and sixty degrees relative to the second housing, wherein the second housing includes a first portion and a second portion; and
means for rotating the second portion relative to the first portion about a second hinge, wherein the second portion can rotate about three hundred and sixty degrees relative to the first portion.

21. The system of claim 20, wherein the first housing includes a display and the first portion includes a keyboard.

22. The system of claim 21, wherein the second portion can rotate and cover at least a portion of the keyboard.

23. The system of claim 22, wherein the second housing can rotate behind the display.

24. The system of claim 21, wherein the second portion can rotate and cover at least a portion of the keyboard and the second housing can rotate in front of the display such that only a portion of display is visible.

25. The system of claim 20, wherein the second portion includes a touchpad.
